(19) United States
(12) Patent Application Publication
(10) Pub. No.: US 2026/0171323 A1
(43) Pub. Date: Jun. 18, 2026

(54) ELECTRONIC COMPONENT

(71) Applicant: TDK Corporation, Tokyo (JP)

(72) Inventors: Atsuhiro TSUYOSHI, Tokyo (JP); Takashi OHTSUKA, Tokyo (JP); Yoshinori UCHIYAMA, Tokyo (JP); Yu FUKAE, Tokyo (JP); Yukari TANZAWA, Tokyo (JP); Takeshi OOHASHI, Tokyo (JP)

(73) Assignee: TDK Corporation, Tokyo (JP)

(21) Appl. No.: 19/128,173

(22) PCT Filed: Nov. 17, 2023
(86) PCT No.: PCT/JP2023/041407

§ 371 Date: May 8, 2025

(30) Foreign Application Priority Data
Nov. 25, 2022 (JP) 2022-187845

(51) Int. Cl. H01G 4/33; H01F 17/00; H01F 27/29; H01F 27/32; H01G 4/06; H01G 4/40

(52) U.S. Cl. CPC H01G 4/33; H01F 17/0006; H01F 27/29; H01F 27/32; H01G 4/06; H01G 4/40; H01F 2017/0086

(57) ABSTRACT

An electronic component includes: an insulating layer covering the surface of a substrate; an adhesion layer provided on the surface of the insulating layer and extending so as to surround at least a first area which is a partial area of the insulating layer; a lower electrode pattern provided in the first area; an insulating layer provided in the first area so as to cover the lower electrode pattern; an upper electrode pattern covering the lower electrode pattern through the insulating layer; and an interlayer insulating film provided on the insulating layer and embedding therein the adhesion layer, lower electrode pattern, insulating layer, and upper electrode pattern. The edge of the insulating layer is positioned on the adhesion layer.

### TECHNICAL FIELD

The present disclosure relates to an electronic component and, more particularly, to an electronic component having a capacitor on a substrate.

### BACKGROUND ART

Patent Document 1 discloses a surface-mount chip-type electronic component having a capacitor on a substrate.

### CITATION LIST

### Patent Document

[Patent Document 1] JP 2022-094391A

### DISCLOSURE OF THE INVENTION

### Problem to be Solved by the Invention

In electronic components of this type, peeling or cracks occurring in the constituent elements of a capacitor may affect their reliability.

The present disclosure describes a technology for providing an electronic component having a highly reliable capacitor.

### Means for Solving the Problem

An electronic component according to an aspect of the present disclosure includes: a substrate; a first insulating layer covering the surface of the substrate; an adhesion layer provided on the surface of the first insulating layer and extending so as to surround at least a partial area of the first insulating layer; a lower electrode pattern provided in a first area of the first insulating layer that is surrounded by the adhesion layer; a second insulating layer provided in the first area so as to cover the lower electrode pattern; an upper electrode pattern covering the lower electrode pattern through the second insulating layer; and an interlayer insulating film provided on the first insulating layer and embedding therein the adhesion layer, the lower electrode pattern, the second insulating layer, and the upper electrode pattern, wherein the edge of the second insulating layer is positioned on the adhesion layer.

### Advantageous Effects of the Invention

In this manner, according to the technology of the present disclosure, an electronic component having a highly reliable capacitor can be obtained.

### BRIEF DESCRIPTION OF THE DRAWINGS

FIG. 1 is a schematic perspective view illustrating the outer appearance of an electronic component 100 according to an embodiment of the technology according to the present disclosure.

FIG. 2 is a schematic cross-sectional view of the electronic component 100.

FIG. 3 is an equivalent circuit of the electronic component 100.

FIG. 4 is a schematic plan view illustrating the pattern shapes of the conductor layers M1 and MM.

FIG. 5 is a graph schematic plan view illustrating an example of the pattern shape of the adhesion layer 13.

FIG. 6 is a graph schematic plan view illustrating another example of the pattern shape of the adhesion layer 13.

FIG. 7 is a schematic plan view illustrating an example in which eight slits SL1 to SL8 are formed in the adhesion layer 13.

FIG. 8 is a schematic plan view illustrating the pattern shapes of the conductor layer M2.

FIG. 9 is a schematic plan view illustrating the pattern shapes of the conductor layer M3.

FIG. 10 is a schematic plan view illustrating the pattern shapes of the conductor layers M4 and M5.

FIG. 11 is a schematic cross-sectional view taken along the line A-A in FIG. 4.

### MODE FOR CARRYING OUT THE INVENTION

Hereinafter, preferred embodiments of the present invention will be described in detail with reference to the accompanying drawings.

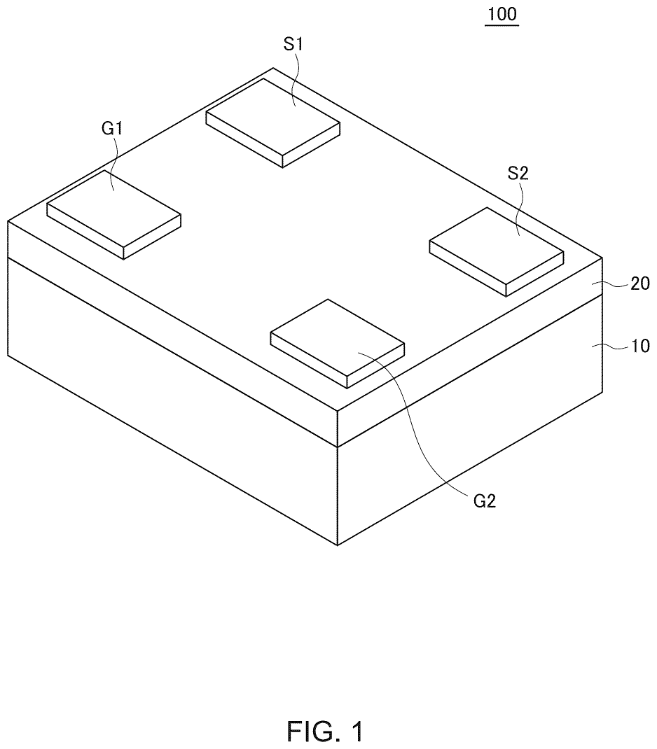

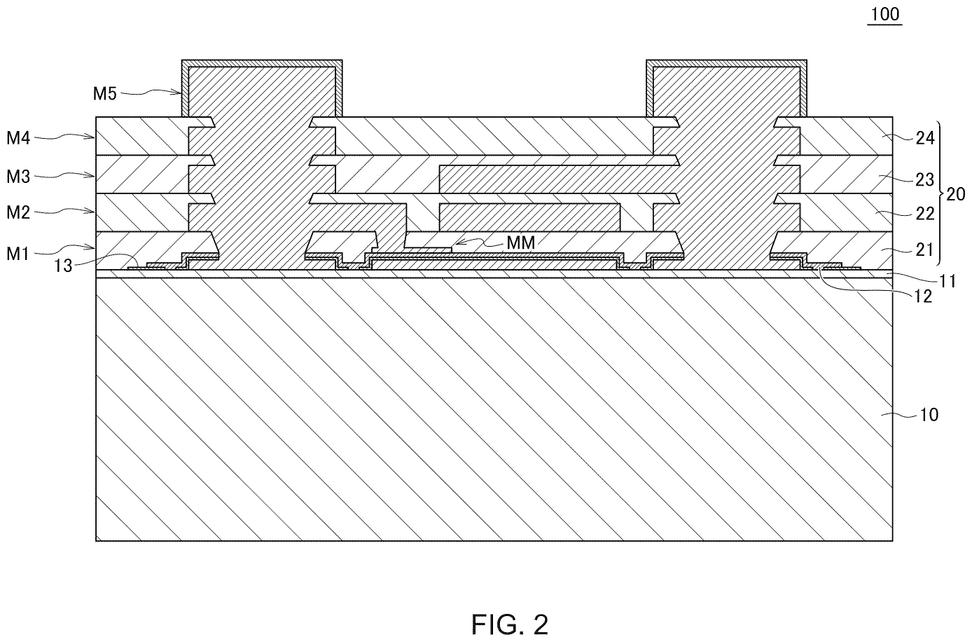

FIG. 1 is a schematic perspective view illustrating the outer appearance of an electronic component 100 according to an embodiment of the technology according to the present disclosure. FIG. 2 is a schematic cross-sectional view of the electronic component 100.

The electronic component 100 according to the present embodiment is a surface-mount type high-pass filter and has a substrate 10, an interlayer insulating film 20 formed on the surface of the substrate 10, and signal terminals S1, S2 and ground terminals G1, G2 which are formed on the surface of the interlayer insulating film 20, as illustrated in FIG. 1. As illustrated in FIG. 2, the surface of the substrate 10 is covered with an insulating layer 11 provided for planarization, etc., and a plurality of conductor layers M1 to M4 and MM each covered with the interlayer insulating film 20 are provided on the insulating layer 11. The conductor layers M1 to M4 and MM are each made of a good conductor such as copper (Cu). The signal terminals S1, S2 and ground terminals G1, G2 are formed on a conductor layer M5 positioned in the uppermost layer. The interlayer insulating film 2 includes four interlayer insulating films 21 to 24. The material of the interlayer insulating film 20 may be an organic insulating material such as polyimide resin, epoxy resin, or benzocyclobutene resin.

The material of the substrate 10 is not particularly limited as long as it is chemically and thermally stable, generates less stress, and can maintain surface smoothness, and examples thereof include silicon single crystal, alumina, sapphire, aluminum nitride, MgO single crystal, SrTiO₃ single crystal, surface-oxidized silicon, glass, quartz, and ferrite. The material of the insulating layer 11 may be an inorganic insulating material such as alumina (Al₂O₃), silicon nitride (Si₃N₄), or silicon oxide (SiO₂). When the insulating layer 11 is made of an inorganic material, adhesion between the insulating layer 11 and the interlayer insulating film 21 made of an organic insulating material may become insufficient and, in this case, peeling is likely to occur at the interface therebetween.

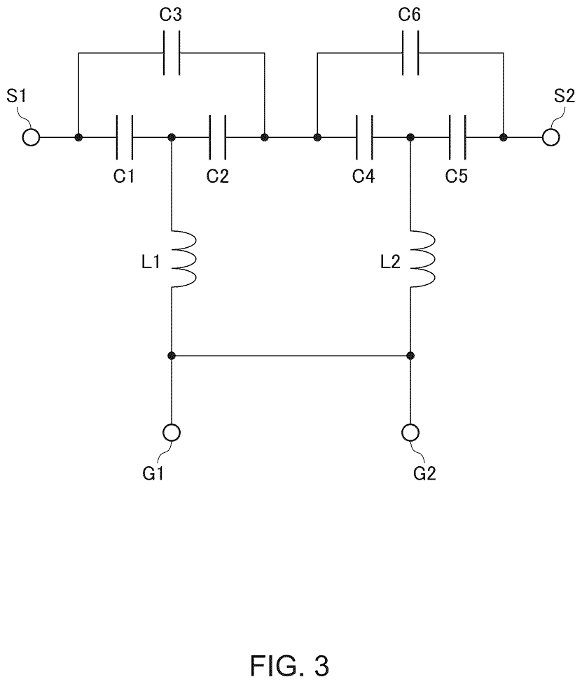

FIG. 3 is an equivalent circuit of the electronic component 100 according to the present embodiment.

As illustrated in FIG. 3, the electronic component 100 according to the present embodiment has capacitors C1, C2, C4, and C5 connected in series between the signal terminals S1 and S2, a capacitor C3 connected in parallel to the capacitors C1 and C2, a capacitor C6 connected in parallel to the capacitors C4 and C5, an inductor L1 connected between the connection point between the capacitors C1 and C2 and ground terminals G1, G2, and an inductor L2 connected between the connection point between the capacitors C4 and C5 and the ground terminals G1, G2. With this configuration, the electronic component 100 according to the present embodiment functions as a high-pass filter. The frequency characteristics of the high-pass filter are basically determined by the capacitances of the capacitors C1 to C6 and inductances of the inductors L1 and L2.

The following describes the structure of each of the conductor layers M1 to M5 and MM included in the electronic component 100.

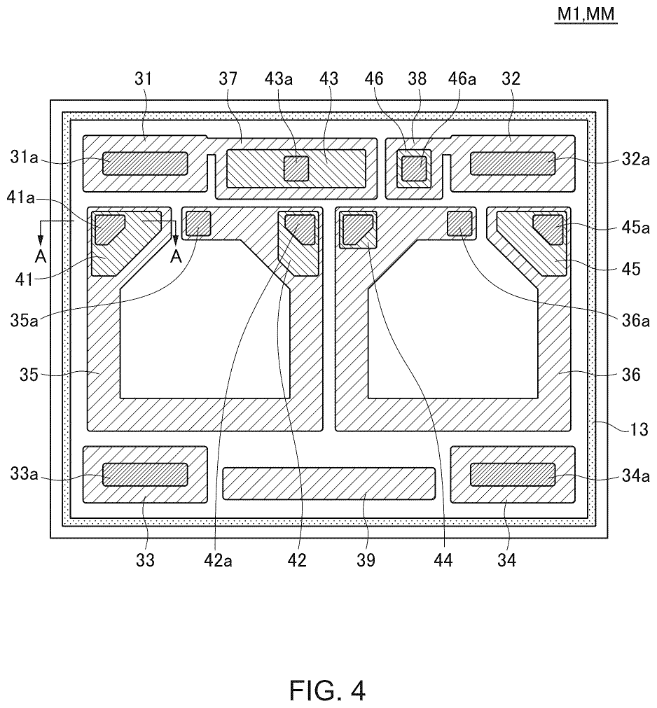

The conductor layer M1 is a conductor layer positioned in the lowermost layer and includes conductor patterns 31 to 34, winding patterns 35 and 36, lower electrode patterns 37 and 38, and a dummy pattern 39, as illustrated in FIG. 4. The conductor patterns 31, 32, 33, and 34 are provided at positions overlapping respectively the signal terminals S1, S2 and ground terminals G1, G2 in a plan view. The winding patterns 35 and 36 are patterns wound in about one turn and respectively constitute a part of the inductor L1 and a part of the inductor L2. The lower electrode patterns 37 and 38 are disposed between the conductor patterns 31 and 32. The lower electrode pattern 37 is connected to the conductor pattern 31, and the lower electrode pattern 38 is connected to the conductor pattern 32. The dummy pattern 39 is disposed between the conductor patterns 33 and 34 and is not connected to any of the conductor patterns. The conductor patterns 31, 32, 33, and 34 and winding patterns 35 and 36 are respectively connected to the upper conductor layer M2 through respective via holes 31a, 32a, 33a, 34a, 35a, and 36a formed in the interlayer insulating film 21.

As illustrated in FIG. 2, the surface of the conductor layer M1 is covered with the insulating layer 12 which is a capacitor capacitive insulating film, and the conductor layer MM is provided on the insulating layer 12. The material of the insulating layer 12 may be an inorganic insulating material such as silicon nitride (Si₃N₄) or silicon oxide (SiO₂). When the insulating layer 12 is made of an inorganic insulating material different from that for insulating layer 11, adhesion between the insulating layers 11 and 12 may become insufficient.

As illustrated in FIG. 4, the conductor layer MM includes upper electrode patterns 41 to 46. The upper electrode patterns 41 and 42 are disposed at positions overlapping a part of the winding pattern 35, and the upper electrode patterns 44 and 45 are disposed at positions overlapping a part of the winding pattern 36. More in detail, the upper electrode pattern 41 is disposed at a position overlapping one end of the winding pattern 35, and the upper electrode pattern 45 is disposed at a position overlapping one end of the winding pattern 36. The upper electrode pattern 42 is disposed at a position near the other end of the winding pattern 35, and the upper electrode pattern 44 is disposed at a position near the other end of the winding pattern 36. A part of the winding pattern 35 that overlaps the upper electrode patterns 41 and 42 and a part of the winding pattern 36 that overlaps the upper electrode patterns 44 and 45 function as lower electrodes. As a result, the winding pattern 35, upper electrode pattern 41, and insulating layer 12 constitute the capacitor C1, and the winding pattern 35, upper electrode pattern 42, and insulating layer 12 constitute the capacitor C2. Similarly, the winding pattern 36, upper electrode pattern 44, and insulating layer 12 constitute the capacitor C4, and the winding pattern 36, upper electrode pattern 45, and insulating layer 12 constitute the capacitor C5. The upper electrode patterns 43 and 46 are provided at positions overlapping respectively the lower electrode patterns 37 and 38. As a result, the lower electrode pattern 37, upper electrode pattern 43, and insulating layer 12 constitute the capacitor C3, and the lower electrode pattern 38, upper electrode pattern 46, and insulating layer 12 constitute the capacitor C6. The upper electrode patterns 41, 42, 43, 44, 45, and 46 are respectively connected to the upper conductor layer M2 through respective via holes 41a, 42a, 43a, 44a, 45a, and 46a formed in the interlayer insulating film 21.

In the present embodiment, an adhesion layer 13 is provided between the insulating layers 11 and 12. The adhesion layer 13 is made of a metal material having high adhesion, such as chrome (Cr), titanium (Ti), tantalum (Ta), aluminum (Al), or nickel (Ni), an alloy containing one of these metals, or an oxide or a nitride thereof. The adhesion layer 13 is interposed between the insulating layers 11 and 12 to act to prevent peeling at the interface therebetween. These materials have higher adhesion to an inorganic or organic material than copper (Cu) constituting the conductor layers M1 to M5 and MM.

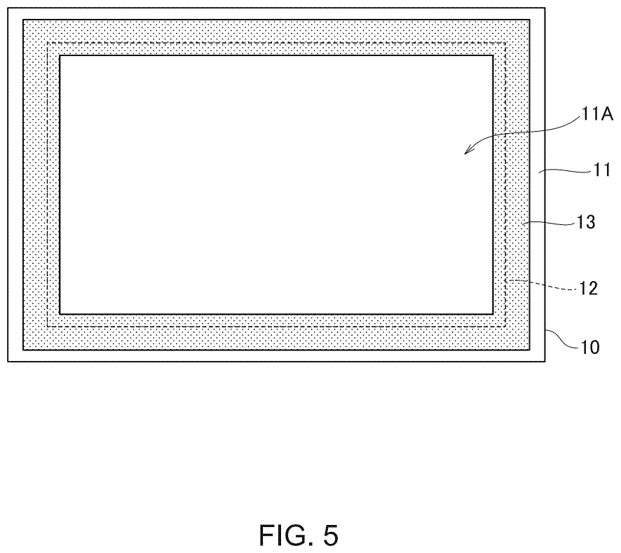

The adhesion layer 13 is provided on the surface of the insulating layer 11 and extends so as to surround at least a partial area (hereinafter, sometimes referred to as “a first area”) of the insulating layer 11. In the specific example of FIG. 5, the adhesion layer 13 annularly extends along the outer periphery of the insulating layer 11 to form a center area 11A (first area) surrounded thereby. The conductor patterns included in the conductor layers M1 to M5 and MM are arranged on the center area 11A of the insulating layer 11 in a plan view. The insulating layer 12 is formed such that the edge thereof overlaps the adhesion layer 13. As a result, the insulating layer 12 does not directly contact the insulating layer 11 at its edge portion, and the adhesion layer 13 is interposed between the insulating layer 12 and the adhesion layer 11. As illustrated in FIG. 5, the edge position of the insulating layer 12 may be closer to the inner peripheral edge of the adhesion layer 13 than to the outer peripheral edge thereof.

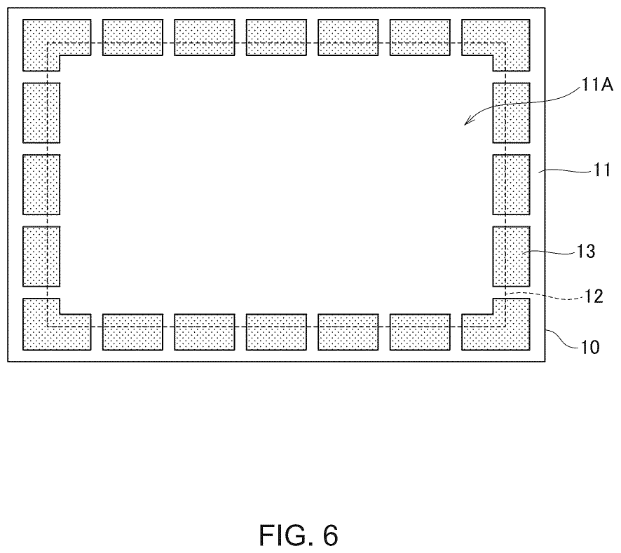

The adhesion layer 13 may have a continuous annular structure as illustrated in FIG. 5 or may have an intermittent annular structure as illustrated in FIG. 6. That is, it is sufficient for the adhesion layer 13 to extend along the outer periphery of the insulating layer 11 so as to surround the center area 11A of the insulating layer 11. When slits are formed in the adhesion layer 13 to intermittently surround the center area 11A as illustrated in FIG. 6, the number of slits to be formed in the adhesion layer 13 is not particularly limited and may be two, four, eight, or sixteen or more.

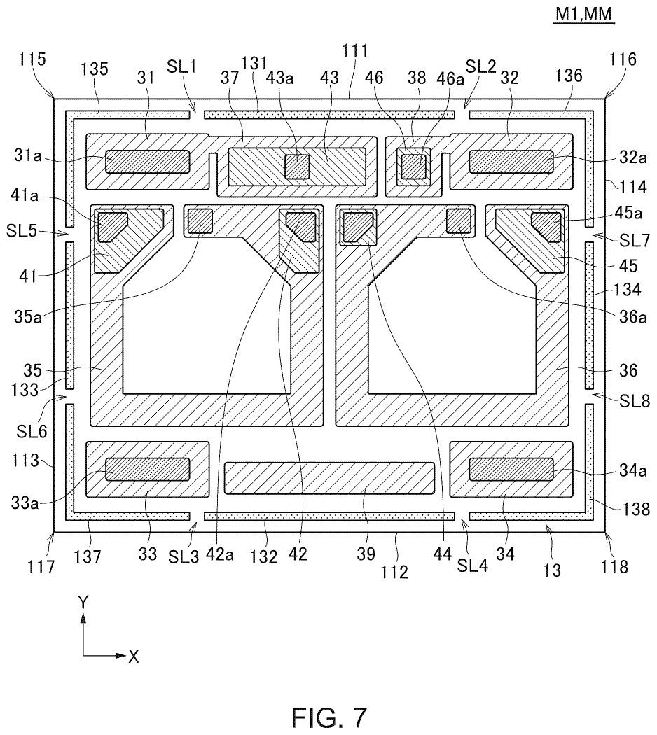

FIG. 7 is a schematic plan view illustrating an example in which eight slits SL1 to SL8 are formed in the adhesion layer 13.

In the example illustrated in FIG. 7, the adhesion layer 13 is separated into eight segments 131 to 138 by the slits SL1 to SL8. The insulating layer 11 has, along its outer periphery, sides 111 and 112 extending in the X-direction, sides 113 and 114 extending in the Y-direction, a corner 115 at which the sides 111 and 113 are terminated, a corner 116 at which the sides 111 and 114 are terminated, a corner 117 at which the sides 112 and 113 are terminated, and a corner 118 at which the sides 112 and 114 are terminated. The segment 131 extends in the X-direction along the side 111 of the insulating layer 11, the segment 132 extends in the X-direction along the side 112 of the insulating layer 11, the segment 133 extends in the Y-direction along the side 113 of the insulating layer 11, and the segment 134 extends in the Y-direction along the side 114 of the insulating layer 11. The segment 135 extends in an L-shape along the side 111, corner 115, and side 113 of the insulating layer 11. The segment 136 extends in an L-shape along the side 111, corner 116, and side 114 of the insulating layer 11. The segment 137 extends in an L-shape along the side 112, corner 117, and side 113 of the insulating layer 11. The segment 138 extends in an L-shape along the side 112, corner 118, and side 114 of the insulating layer 11.

The slit SL1 separates the segments 131 and 135. The slit SL2 separates the segments 131 and 136. The slit SL3 Separates the segments 132 and 137. The slit SL4 separates the segments 132 and 138. The slit SL5 separates the segments 133 and 135. The slit SL6 separates the segments 133 and 137. The slit SL7 separates the segments 134 and 136. The slit SL8 separates the segments 134 and 138.

The slits SL1 and SL2 are formed at positions along the side 111 of the insulating layer 11. The slits SL3 and SL4 are formed at positions along the side 112 of the insulating layer 11. The slits SL3 and SL4 are formed at positions along the side 113 of the insulating layer 11. The slits SL7 and SL8 are formed at positions along the side 114 of the insulating layer 11.

The conductor pattern 31 connected to the signal terminal S1 overlaps the segment 135 in the X-and Y-directions. The conductor pattern 32 connected to the signal terminal S2 overlaps the segment 136 in the X-and Y-directions. The conductor pattern 33 connected to the ground terminal G1 overlaps the segment 137 in the X-and Y-directions. The conductor pattern 34 connected to the ground terminal G2 overlaps the segment 138 in the X-and Y-directions.

The positions of the slits SL1, SL2, SL3, and SL4 in the X-direction overlap the conductor patterns 31, 32, 33, and 34, respectively. The positions of the slits SL5 and SL6 in the Y-direction overlap the winding pattern 35. The positions of the slits SL7 and SL8 in the Y-direction overlap the winding pattern 36.

Forming such slits SL1 to SL8 in the adhesion layer 13 splits an unintended propagation path for high-frequency signals which is formed through stray capacitance generated between the adhesion layer 13 (segments 131 to 138) and the conductor layer M1 (conductor patterns 31 to 34, winding patterns 35, 36, lower electrode patterns 37, 38, and dummy pattern 39). Specifically, the slits SL1 and SL2 split a propagation path connecting, through the adhesion layer 13, the conductor patterns 31 and 32 connected respectively to the signal terminals S1 and S2. The slit SL3 splits a propagation path connecting, through the adhesion layer 13, the conductor pattern 33 connected to the ground terminal G1 and the dummy pattern 39. The slit SL4 splits a propagation path connecting, through the adhesion layer 13, the conductor pattern 34 connected to the ground terminal G2 and the dummy pattern 39. The slit SL5 splits a propagation path connecting, through the adhesion layer 13, the conductor pattern 31 connected to the signal terminal S1 and the winding pattern 35. The slit SL6 splits a propagation path connecting, through the adhesion layer 13, the conductor pattern 33 connected to the ground terminal G1 and the winding pattern 35. The slit SL7 splits a propagation path connecting, through the adhesion layer 13, the conductor pattern 32 connected to the signal terminal S2 and the winding pattern 36. The slit SL8 splits a propagation path connecting, through the adhesion layer 13, the conductor pattern 34 connected to the ground terminal G2 and the winding pattern 36.

As described above, in the example illustrated in FIG. 7, the adhesion layer 13 is separated into eight segments 131 to 138 by the slits SL1 to SL8, thus suppressing coupling between adjacent patterns in the conductor layer M1 through the adhesion layer 13. In addition, in the example of FIG. 7, the conductor patterns 31, 32, 33, and 34 are present at positions respectively adjacent in the Y-direction to the slits SL1, SL2, SL3, and SL4, the winding pattern 35 is present at a position adjacent in the X-direction to the slits SL5 and SL6, and the winding pattern 36 is present at a position adjacent in the X-direction to the slits SL7 and SL8. Thus, as compared with when the slits SL1 to SL8 are disposed at positions not adjacent to their corresponding conductor patterns, the occurrence of peeling due to the presence of the slits SL1 to SL8 can be suppressed. To suppress the occurrence of peeling more effectively, the widths of the slits SL1 to SL8 may be set equal to or less than the width of the adhesion layer 13.

The structure of the adhesion layer 13 in FIG. 7 is merely illustrative and may be variously modified. For example, although two slits are formed along each of the sides 111 to 114 of the insulating layer 11 in the example of FIG. 7, the number of slits to be formed along each of the sides 111 to 114 may be one or three or more. Further, the number of slits formed along each of the longer sides 111 and 112 may be larger than the number of slits formed along the shorter sides 113 and 114.

Further, the adhesion layer 13 includes not only a part that annularly extends along the outer periphery of the insulating layer 11, but also a part that is formed on the surface of the conductor layer M1. This structure is less apt to cause peeling between the lower electrode patterns formed by the conductor layer M1 and the insulating layer 12. However, when the adhesion layer 13 is made of a conductive material, the adhesion layer 13 is not formed on the entire surface of the center area 11A of the insulating layer 11 but is separated into patterns constituting the conductor layer M1. Further, in this case, the part that extends along the outer periphery of the insulating layer 11 may be in a floating state without being connected to any conductor pattern.

The adhesion layer 13 may be formed at any timing after formation of the insulating layer 11 and before formation of the insulating layer 12; however, when the adhesion layer 13 is also formed on the surface of the conductor layer M1, the adhesion layer 13 is formed after formation of the conductor layer M1 and before formation of the insulating layer 12. The insulating layer 11, conductor layer M1, adhesion layer 13, insulating layer 12, and conductor layer MM are embedded in the interlayer insulating film 21.

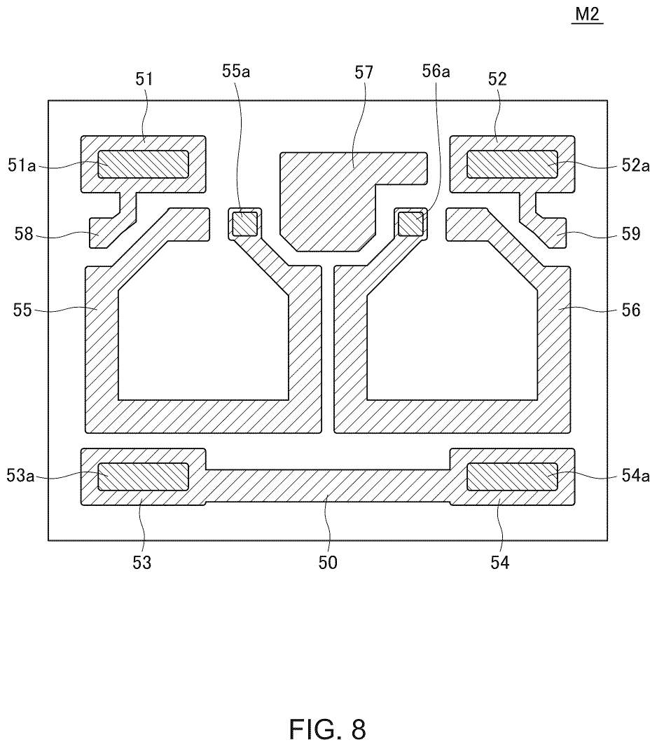

The conductor layer M2 is provided in the upper layer of the conductor layer M1 through the interlayer insulating film 21 and includes conductor patterns 50 to 54 and 57 and connection patterns 58 and 59, and winding patterns 55 and 56 as illustrated in FIG. 8. The conductor patterns 51, 52, 53, and 54 are connected respectively to the conductor patterns 31, 32, 33, and 34 of the conductor layer M1 through the respective via holes 31a to 34a. The winding patterns 55 and 56 are patterns each wound in about one turn and respectively constitute a part of the inductor L1 and a part of the inductor L2. One ends of the winding patterns 55 and 56 are connected respectively to the other ends of the winding patterns 35 and 36 of the conductor layer M1 through the respective via holes 35a and 36a formed in the interlayer insulating film 21. The conductor pattern 57 is connected in common to the upper electrode patterns 42, 43, 44, and 46 of the conductor layer M1 through the via holes 42a, 43a, 44a, and 46a formed in the interlayer insulating film 21. The connection pattern 58 is a pattern protruding from the conductor pattern 51 toward the winding pattern 55. The connection pattern 58 is connected to the conductor pattern 51 in the same surface and connected to the upper electrode pattern 41 of the conductor layer M1 through the via hole 41a formed in the interlayer insulating film 21. The connection pattern 59 is a pattern protruding from the conductor pattern 52 toward the winding pattern 56. The connection pattern 59 is connected to the conductor pattern 52 in the same surface and connected to the upper electrode pattern 45 of the conductor layer M1 through the via hole 45a formed in the interlayer insulating film 21. The conductor pattern 50 is a pattern connecting the conductor patterns 53 and 54 and acts to short-circuit the ground terminals G1 and G2. There exists the dummy pattern 39 at a position overlapping the conductor pattern 50, thereby maintaining flatness. The conductor patterns 51, 52, 53, and 54 and winding patterns 55 and 56 are connected to the upper conductor layer M3 through respective via holes 51a, 52a, 53a, 54a, 55a, and 56a formed in the interlayer insulating film 22.

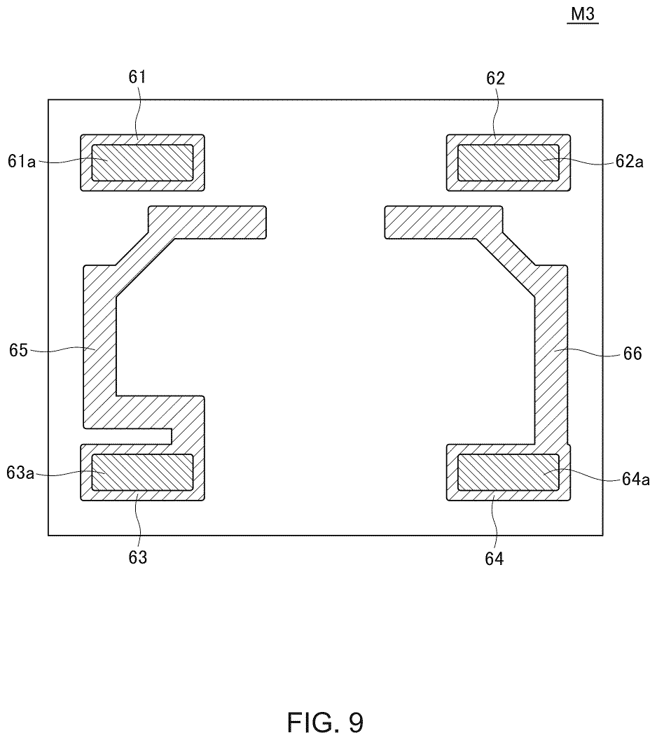

The conductor layer M3 is provided in the upper layer of the conductor layer M2 through the interlayer insulating film 22 and includes conductor patterns 61 to 64 and winding patterns 65 and 66 as illustrated in FIG. 9. The conductor patterns 61, 62, 63, and 64 are connected respectively to the conductor patterns 51, 52, 53, and 54 of the conductor layer M2 through the respective via holes 51a, 52a, 53a, and 54a formed in the interlayer insulating film 22. The winding patterns 65 and 66 are patterns each wound in about 0.5 turns and respectively constitute a part of the inductor L1 and a part of the inductor L2. One ends of the winding patterns 65 and 66 are connected respectively to the other ends of the winding patterns 55 and 56 of the conductor layer M2 through the respective via holes 55a and 56a formed in the interlayer insulating film 22. The other ends of the winding patterns 65 and 66 are connected respectively to the conductor patterns 63 and 64. The conductor patterns 61, 62, 63, and 64 are connected to the upper conductor layer M4 through respective via holes 61a, 62a, 63a, and 64a formed in the interlayer insulating film 23.

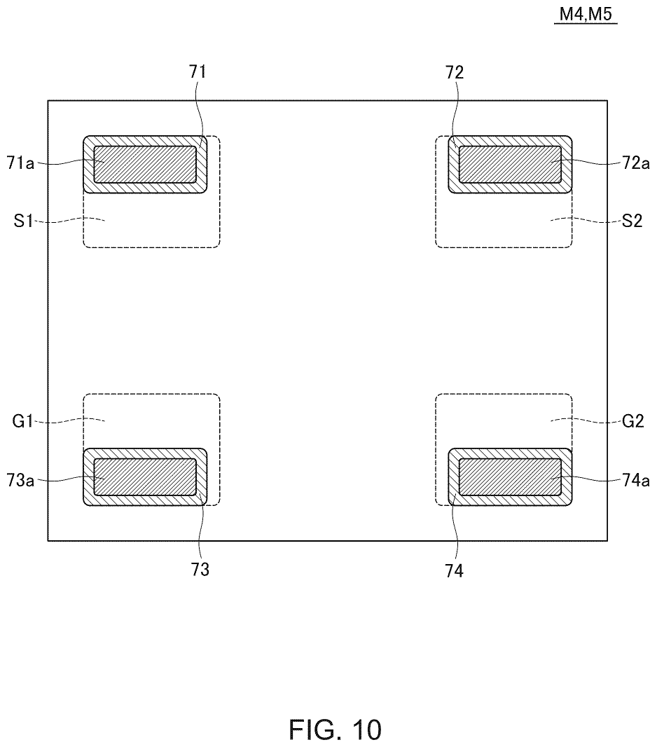

The conductor layer M4 is provided in the upper layer of the conductor layer M3 through the interlayer insulating film 23 and includes conductor patterns 71 to 74 as illustrated in FIG. 10. The conductor patterns 71, 72, 73, and 74 are connected respectively to the conductor patterns 61, 62, 63, and 64 of the conductor layer M3 through the respective via holes 61a, 62a, 63a, and 64a formed in the interlayer insulating film 23 and connected to the upper conductor layer M5 through respective via holes 71a, 72a, 73a, and 74a formed in the interlayer insulating film 24. The conductor layer M5 includes the signal terminals S1, S2 and ground terminals G1, G2. The signal terminals S1, S2 and ground terminals G1, G2 are connected respectively to the conductor patterns 71, 72, 73, and 74 of the conductor layer M4 through the respective via holes 71a, 72a, 73a, and 74a formed in the interlayer insulating film 24. The above-described conductor layers M1 to M5 and MM are all made of a good conductor such as Cu (copper). The signal terminals S1, S2 and ground terminals G1, G2 may be subjected to surface treatment for enhancing soldering wettability.

With the above pattern structure, the inductor L1 is constituted by the winding patterns 35, 55, 65, and 75, and the inductor L2 is constituted by the winding patterns 36, 56, 66, and 76. The winding directions of the inductors L1 and L2 with the ground terminals G1 and G2 as starting points, respectively, are opposite to each other, whereby current flows in the same direction in the sections adjacent to the inductors L1 and L2 in the same conductor layer.

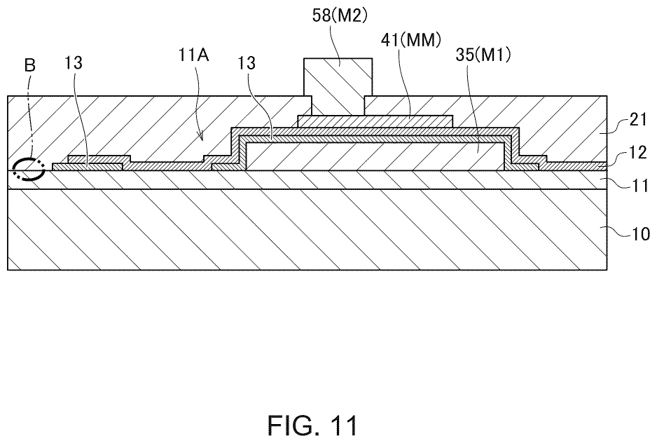

FIG. 11 is a schematic cross-sectional view taken along the line A-A in FIG. 4.

As illustrated in FIG. 11, in the present embodiment, the adhesion layer 13 annularly extends along the outer periphery of the insulating layer 11 so as to surround the center area 11A of the insulating layer 11. Further, since the insulating layer 12 functioning as a capacitive insulating film is formed such that the edge thereof overlaps the adhesion layer 13, peeling hardly occurs at the edge portion of the insulating layer 12. That is, a peeling B may occur in the interface between the insulating layer 11 and the interlayer insulating film 21, starting from the outer periphery due to low adhesion therebetween. However, even when such peeling progresses inward, the peeling stops at the edge portion of the insulating layer 12 due to overlap between the edge of the insulating layer 12 and the adhesion layer 13. This prevents the occurrence of cracks associated with the peeling, which in turn can prevent fluctuation of a capacitance value caused due to cracks in the insulating layer 12.

The edge of the insulating layer 12 is not particularly limited in position as long as it overlaps the adhesion layer 13; however, when the edge position is made closer to the inner peripheral edge of the adhesion layer 13 than to the outer peripheral edge thereof, that is, when the edge position is set inside the center position of the adhesion layer 13 in the width direction thereof, an effect of stopping the progress of peeling is enhanced. Further, in the present embodiment, the adhesion layer 13 is present also on the surface of the conductor layer M1, making it also possible to prevent peeling between the lower electrode pattern constituted by the conductor layer M1 and the insulating layer 12.

While the preferred embodiment of the present disclosure has been described, the present disclosure is not limited to the above embodiment, and various modifications may be made within the scope of the present disclosure, and all such modifications are included in the present disclosure.

For example, the adhesion layer 13 may be formed so as to surround substantially the center area on the surface of the insulating layer 11 as in the above-described embodiment, or may be formed so as to surround another area (e.g., a specific area offset to any direction in a top view). Further, the adhesion layer 13 may be formed into a substantially linear shape following the outer edge of the insulating layer 11 as in the above-described embodiment or may partially have a bent part, a deflected part, a meandering part, or the like.

The technology according to the present disclosure includes the following configuration examples but not limited thereto.

An electronic component according to an aspect of the present disclosure includes: a substrate; a first insulating layer covering the surface of the substrate; an adhesion layer provided on the surface of the first insulating layer and extending so as to surround at least a partial area of the first insulating layer; a lower electrode pattern provided in a first area of the first insulating layer that is surrounded by the adhesion layer; a second insulating layer provided in the first area so as to cover the lower electrode pattern; an upper electrode pattern covering the lower electrode pattern through the second insulating layer; and an interlayer insulating film provided on the first insulating layer and embedding therein the adhesion layer, the lower electrode pattern, the second insulating layer, and the upper electrode pattern, wherein the edge of the second insulating layer is positioned on the adhesion layer. With this configuration, the progress of peeling of the interlayer insulating film stops at the edge portion of the second insulating layer, and thus, cracks and the like are less likely to occur in the second insulating layer that functions as a capacitive insulating film. This increases reliability of capacitor constituent elements, so that there can be provided an electronic component having a capacitor with high reliability.

In the above electronic component, the adhesion layer may be formed along the outer periphery of the first insulating layer at the outer edge portion of the first insulating layer so as to surround the first area. This can effectively stop the progress of peeling starting from the outer edge portion of the first insulating layer.

In the above electronic component, the edge position of the second insulating layer may be closer to the inner peripheral edge of the adhesion layer than to the outer peripheral edge of the adhesion layer. This can effectively stop the progress of peeling.

In the above electronic component, the first insulating layer and the second insulating layer may be made of mutually different inorganic insulating materials, the adhesion layer may be made of a conductive material different from those of the lower electrode pattern and the upper electrode pattern, and the interlayer insulating film may be made of an organic insulating material. Thus, peeling between different materials can be suppressed by the adhesion layer.

In the above electronic component, the adhesion layer may contain Cr, Ti, Ta, Al, or Ni. This can achieve high adhesion to the inorganic material or organic material.

In the above electronic component, the first insulating layer may contain Al₂O₃, Si₃N₄, or SiO₂. This can achieve sufficient surface smoothness.

In the above electronic component, the second insulating layer may contain Si₃N₄ or SiO₂. This can achieve sufficient capacitance.

In the above electronic component, the interlayer insulating film may contain polyimide resin, epoxy resin, or benzocyclobutene resin. This can achieve high embedding characteristics.

In the above electronic component, the adhesion layer may have one or two or more slits. This can prevent unintended signal propagation through the adhesion layer.

The above electronic component may further include a plurality of terminal electrodes disposed at positions overlapping the first area in a plan view. The outer periphery of the first insulating layer may have a first side, the plurality of terminal electrodes may include first and second terminal electrodes disposed along the first side in a plan view, the adhesion layer may include a first segment provided along the first side and adjacent to the first terminal electrode and a second segment provided along the first side and adjacent to the second terminal electrode, and the slit may separate the first segment and the second segment. This can suppress unintended coupling between the first and second terminal electrodes through the adhesion layer.

In the above electronic component, the adhesion layer may be separated, by the slit, into a plurality of segments disposed adjacent respectively to the plurality of terminal electrodes. The slit separates the plurality of segments. This can suppress unintended coupling between the plurality of terminal electrodes through the adhesion layer.

In the above electronic component, the lower electrode pattern may be formed in a first conductor layer, the first conductor layer may have a plurality of conductor patterns including the lower electrode pattern, and the slit may be disposed at a position adjacent to each of the plurality of conductor patterns. This can suppress the occurrence of peeling caused due to the presence of the slit.

In the above electric component, the interlayer insulating film may include a first interlayer insulating film embedding therein the adhesion layer, the lower electrode pattern, the second insulating layer, and the upper electrode pattern and one or two or more second interlayer insulating films stacked on the first interlayer insulating film, and the plurality of terminal electrodes may be provided in the outermost layer of the second interlayer insulating film. Thus, there can be provided a surface-mount type electronic component including a plurality of conductor layers.

### REFERENCE SIGNS LIST

10 substrate
11, 12 insulating layer
11A center area
13 adhesion layer
20-24 interlayer insulating film
31-34 conductor pattern
31a-36a via hole
35, 36, 55, 56, 65, 66, 75, 76 winding pattern
37, 38 lower electrode pattern
39 dummy pattern
41-46 upper electrode pattern
41a-46a via hole
50-54, 57 conductor pattern
51a-56a via hole
58, 59 connection pattern
61-64 conductor pattern
61a 64a via hole
71-74 conductor pattern
71a-74a via hole
100 electronic component
111-114 side
115-118 corner
131-138 segment
B peeling
C1-C6 capacitor
G1, G2 ground terminal
L1, L2 inductor
M1-M5, MM conductor layer
S1, S2 signal terminal
SL1-SL8 slit

1. An electronic component comprising:
a substrate;
a first insulating layer covering a surface of the substrate;
an adhesion layer provided on a surface of the first insulating layer and extending so as to surround at least a partial area of the first insulating layer;
a lower electrode pattern provided in a first area of the first insulating layer that is surrounded by the adhesion layer;
a second insulating layer provided in the first area so as to cover the lower electrode pattern;
an upper electrode pattern covering the lower electrode pattern through the second insulating layer; and
an interlayer insulating film provided on the first insulating layer and embedding therein the adhesion layer, the lower electrode pattern, the second insulating layer, and the upper electrode pattern,
wherein an edge of the second insulating layer is positioned on the adhesion layer.

2. The electronic component as claimed in claim 1, wherein the adhesion layer is formed along an outer periphery of the first insulating layer at an outer edge portion of the first insulating layer so as to surround the first area.

3. The electronic component as claimed in claim 2, wherein an edge position of the second insulating layer is closer to an inner peripheral edge of the adhesion layer than to an outer peripheral edge of the adhesion layer.

4. The electronic component as claimed in claim 1,
wherein the first insulating layer and the second insulating layer are made of mutually different inorganic insulating materials,
wherein the adhesion layer is made of a conductive material different from those of the lower electrode pattern and the upper electrode pattern, and
wherein the interlayer insulating film is made of an organic insulating material.

5. The electronic component as claimed in claim 4, wherein the adhesion layer contains Cr, Ti, Ta, Al, or Ni.

6. The electronic component as claimed in claim 4, wherein the first insulating layer contains Al₂O₃, Si₃N₄, or SiO₂.

7. The electronic component as claimed in claim 4, wherein the second insulating layer contains Si₃N₄ or SiO₂.

8. The electronic component as claimed in claim 7, wherein the interlayer insulating film contains polyimide resin, epoxy resin, or benzocyclobutene resin.

9. The electronic component as claimed in claim 2, wherein the adhesion layer has one or two or more slits.

10. The electronic component as claimed in claim 9, further comprising a plurality of terminal electrodes disposed at positions overlapping the first area in a plan view,
wherein the outer periphery of the first insulating layer has a first side,
wherein the plurality of terminal electrodes include first and second terminal electrodes disposed along the first side in a plan view,
wherein the adhesion layer includes a first segment provided along the first side and adjacent to the first terminal electrode and a second segment provided along the first side and adjacent to the second terminal electrode, and
wherein the slit separates the first segment and the second segment.

11. The electronic component as claimed in claim 10,
wherein the adhesion layer is separated, by the slit, into a plurality of segments disposed adjacent respectively to the plurality of terminal electrodes, and
wherein the slit separates the plurality of segments.

12. The electronic component as claimed in claim 9,
wherein the lower electrode pattern is formed in a first conductor layer,
wherein the first conductor layer has a plurality of conductor patterns including the lower electrode pattern, and
wherein the slit is disposed at a position adjacent to each of the plurality of conductor patterns.

13. The electronic component as claimed in claim 10,
wherein the lower electrode pattern is formed in a first conductor layer,
wherein the first conductor layer has a plurality of conductor patterns including the lower electrode pattern, and
wherein the slit is disposed at a position adjacent to each of the plurality of conductor patterns.

14. The electronic component as claimed in claim 10,
wherein the interlayer insulating film includes a first interlayer insulating film embedding therein the adhesion layer, the lower electrode pattern, the second insulating layer, and the upper electrode pattern and one or two or more second interlayer insulating films stacked on the first interlayer insulating film, and
wherein the plurality of terminal electrodes are provided in an outermost layer of the second interlayer insulating film.
